(19) United States
(12) Patent Application Publication
(10) Pub. No.: US 2024/0377347 A1
(43) Pub. Date: Nov. 14, 2024

(54) THREADLIKE SENSOR, WEARABLE DEVICE AND METHOD FOR FABRICATING THREADLIKE SENSOR

(71) Applicants: Peking University, Beijing (CN); Peking University First Hospital, Beijing (CN)

(72) Inventors: Yue Cui, Beijing (CN); Li Yang, Beijing (CN)

(21) Appl. No.: 18/489,594

(22) Filed: Oct. 18, 2023

(30) Foreign Application Priority Data
May 10, 2023 (CN) 2023105253871

(51) Int. Cl. G01N 27/28; B29C 63/08; G01N 27/327; G01N 27/403

(52) U.S. Cl. CPC G01N 27/286; B29C 63/08; G01N 27/327; G01N 27/403; B29L 2031/3412

(57) ABSTRACT

The present disclosure relates to the technical field of electrochemistry, and in particular, to a threadlike sensor, a wearable device and a method for fabricating the threadlike sensor. The threadlike sensor includes a thread core, an inner insulating layer, an outside electrode layer and an outer insulating layer. The inner insulating layer covers the thread core with two ends of the thread core being exposed by the inner insulating layer. The outside electrode layer is disposed outside the inner insulating layer. The outer insulating layer covers the outside electrode layer with two ends of the outside electrode layer being exposed by the outer insulating layer. One end of the threadlike sensor is a detection end configured for placement in a human body. The other end of the threadlike sensor is an interface end configured for external connection. The thread core and the outside electrode layer are configured for sensitivity testing.

### CROSS REFERENCE TO RELATED APPLICATION

This patent application claims priority to Chinese Patent Application No. 2023105253871, filed with the China National Intellectual Property Administration on May 10, 2023, which is incorporated herein by reference in its entirety.

### TECHNICAL FIELD

The present disclosure relates to the technical field of electrochemistry, and in particular, to a threadlike sensor, a wearable device and a method for fabricating the threadlike sensor.

### BACKGROUND

A biosensor is an instrument which is sensitive to a biological substance and converts a concentration thereof into an electric signal for detection. A biosensor is an analysis tool or system formed by an immobilized biologically sensitive material as an identifying element (including an enzyme, an antibody, an antigen, a microorganism, a cell, a tissue, a nucleic acid and the like), an appropriate physicochemical transducer (such as an oxygen electrode, a photosensitive tube, a field effect transistor and a piezoelectric crystal) and a signal amplifier. A biosensor in the prior art, when used, typically needs to be implanted in the skin's surface and thus is not flexible and sufficiently comfortable.

### SUMMARY

The present disclosure provides a threadlike sensor to solve or solve in part the following problem, i.e., a biosensor in the prior art, when used, typically needs to be implanted in the skin's surface and thus is not flexible and sufficiently comfortable.

In a first aspect, an embodiment of the present disclosure provides a threadlike sensor, including a thread core, an inner insulating layer, an outside electrode layer and an outer insulating layer, where the inner insulating layer covers the thread core with two ends of the thread core being exposed by the inner insulating layer; the outside electrode layer is disposed outside the inner insulating layer; the outer insulating layer covers the outside electrode layer with two ends of the outside electrode layer being exposed by the outer insulating layer; one end of the threadlike sensor is a detection end configured for placement in a human body; the other end of the threadlike sensor is an interface end configured for external connection; and the thread core and the outside electrode layer are configured for sensitivity testing.

Alternatively, an inner insulating wire is wound around the thread core to form the inner insulating layer, and the inner insulating wire is wound by at least one layer; and/or an outer insulating wire is wound around the outside electrode layer to form the outer insulating layer, and the outer insulating wire is wound by at least one layer.

Alternatively, the outside electrode layer is formed by winding an outside electrode wire around the inner insulating layer, and the outside electrode wire is wound by at least one layer.

Alternatively, the inner insulating layer is an insulating coating or an insulating plating; and/or the outer insulating layer is an insulating coating or an insulating plating.

Alternatively, the thread core is a working electrode; a specific enzyme is disposed on an outer wall surface of the working electrode; the inner insulating layer covers the specific enzyme; and the specific enzyme located at the detection end is exposed by the inner insulating layer.

Alternatively, the thread core is a soft threadlike titanium strip or a soft threadlike gold strip.

Alternatively, the thread core includes an insulating inner core and a Prussian blue-graphite paste layer covering the insulating inner core; and the thread core is a working electrode.

Alternatively, the thread core is a counter electrode, and the outside electrode layer is a working electrode; or, the thread core is a working electrode, and the outside electrode layer is a counter electrode; or, the thread core is a working electrode, and the outside electrode layer includes a counter electrode and a reference electrode; a middle insulating layer is disposed between the counter electrode and the reference electrode; one end of the counter electrode and one end of the reference electrode are arranged stepwise, and the other end of the counter electrode and the other end of the reference electrode are arranged stepwise; and the two ends of the counter electrode and the two ends of the reference electrode are exposed by the outer insulating layer; or, the thread core is a counter electrode, and the outside electrode layer includes a working electrode and a reference electrode; a middle insulating layer is disposed between the working electrode and the reference electrode; one end of the working electrode and one end of the reference electrode are arranged stepwise, and the other end of the working electrode and the other end of the reference electrode are arranged stepwise; and the two ends of the working electrode and the two ends of the reference electrode are exposed by the outer insulating layer.

In a second aspect, an embodiment of the present disclosure provides a wearable device, including a wearing unit provided with the threadlike sensor described above.

In a third aspect, an embodiment of the present disclosure provides a method for fabricating a threadlike sensor, including the following steps:
disposing an inner insulating layer outside a thread core such that the inner insulating layer covers the thread core and two ends of the thread core are exposed by the inner insulating layer;
disposing an outside electrode layer outside the inner insulating layer;
disposing an outer insulating layer outside the outside electrode layer such that the outer insulating layer covers the outside electrode layer and two ends of the outside electrode layer are exposed by the outer insulating layer.

Alternatively, the method includes the following steps when the inner insulating layer includes an inner insulating wire, the outside electrode layer includes an outside electrode wire and the outer insulating layer includes an outer insulating wire:
winding the inner insulating wire around the thread core to form the inner insulating layer, where the inner insulating wire covers the thread core and two ends of the thread core are exposed by the inner insulating wire;
winding the outside electrode wire around the inner insulating layer to form the outside electrode layer; and
winding the outer insulating wire around the outside electrode layer to form the outer insulating layer, where the outer insulating wire covers the outside electrode layer and two ends of the outside electrode layer are exposed by the outer insulating wire.

Alternatively, the method includes the following steps when each of the inner insulating layer, the outside electrode layer and the outer insulating layer is one of a coating and a plating:
disposing the inner insulating layer outside the thread core after covering the two ends of the thread core with a first flexible film such that the inner insulating layer covers the thread core;
disposing the outside electrode layer outside the inner insulating layer;
disposing the outer insulating layer outside the outside electrode layer after covering the two ends of the outside electrode layer with a second flexible film such that the outer insulating layer covers the outside electrode layer;
removing the first flexible film and the second flexible film to expose the two ends of the thread core by the inner insulating layer and expose the two ends of the outside electrode layer by the outer insulating layer.

In the embodiments of the present disclosure, the threadlike sensor includes the thread core, the inner insulating layer, the outside electrode layer and the outer insulating layer, and has the advantages of simple structure, convenient fabrication and low cost. Moreover, the threadlike sensor is of a flexible needle type structure and may be flexibly inserted into a human body. After being placed into the human body, the threadlike sensor is capable of maintaining a bent state. Due to easy bending, the threadlike sensor may change with the surrounding skin tissue environment when the skin is deformed, and thus may provide more comfort with a small influence on the human body. The thread core and the outside electrode layer form a three-electrode system or a two-electrode system, offering the advantages of mature detection technique and accurate detection.

### BRIEF DESCRIPTION OF THE DRAWINGS

In order to describe the technical solutions in the embodiments of the present disclosure more clearly, the accompanying drawings required to describe the embodiments of the present disclosure are briefly described below. Apparently, the accompanying drawings described below are only some embodiments of the present disclosure, and other accompanying drawings may be derived from these accompanying drawings by a person of ordinary skill in the art without creative efforts.

FIG. 1 illustrates a structural schematic diagram of a first threadlike sensor according to the present disclosure;

FIG. 2 illustrates a structural schematic diagram of a second threadlike sensor according to the present disclosure;

FIG. 3 illustrates a structural schematic diagram of a third threadlike sensor according to the present disclosure;

FIG. 4 illustrates a schematic diagram of a fabrication process of a threadlike sensor according to the present disclosure;

FIG. 5 illustrates a first diagram of the electrochemical characterization of a threadlike sensor according to the present disclosure;

FIG. 6 illustrates second diagram of the electrochemical characterization of a threadlike sensor according to the present disclosure;

FIG. 7 illustrates a third diagram of the electrochemical characterization of a threadlike sensor according to the present disclosure;

FIG. 8 illustrates a fourth diagram of the electrochemical characterization of a threadlike sensor according to the present disclosure;

FIG. 9 illustrates a first diagram of a detecting current of a threadlike sensor according to the present disclosure;

FIG. 10 illustrates a second diagram of a detecting current of a threadlike sensor according to the present disclosure;

FIG. 11 illustrates a third diagram of a detecting current of a threadlike sensor according to the present disclosure;

FIG. 12 illustrates a fourth diagram of a detecting current of a threadlike sensor according to the present disclosure;

FIG. 13 illustrates a first diagram of the CV detection of a threadlike sensor according to the present disclosure;

FIG. 14 illustrates a second diagram of the CV detection of a threadlike sensor according to the present disclosure;

FIG. 15 illustrates a first diagram of the stability of a threadlike sensor according to the present disclosure;

FIG. 16 illustrates a second diagram of the stability of a threadlike sensor according to the present disclosure;

FIG. 17 illustrates a first diagram of the flexibility characterization of a threadlike sensor according to the present disclosure;

FIG. 18 illustrates a second diagram of the flexibility characterization of a threadlike sensor according to the present disclosure;

FIG. 19 illustrates a flowchart of a method for fabricating a first threadlike sensor according to the present disclosure;

FIG. 20 illustrates a flowchart of a method for fabricating a second threadlike sensor according to the present disclosure;

FIG. 21 illustrates a flowchart of a method for fabricating a third threadlike sensor according to the present disclosure;

FIG. 22 illustrates a flowchart of a method for fabricating a fourth threadlike sensor according to the present disclosure;

FIG. 23 illustrates a cross-sectional structural schematic diagram of a threadlike sensor according to an embodiment of the present disclosure; and

FIG. 24 illustrates a cross-sectional structural schematic diagram of a threadlike sensor according to another embodiment of the present disclosure.

### LIST OF REFERENCE NUMERALS

1—thread core; 2—outer insulating layer; 3—specific enzyme; 4—counter electrode; 5—reference electrode; 6—outside electrode layer; 7—inner insulating layer; 8—working electrode; and 9—middle insulating layer.

### DETAILED DESCRIPTION OF THE EMBODIMENTS

The technical solutions in the embodiments of the present disclosure will be clearly and completely described below with reference to the accompanying drawings in the embodiments of the present disclosure. Apparently, the described embodiments are merely a part rather than all of the embodiments of the present disclosure. All other embodiments derived from the embodiments of the present disclosure by a person of ordinary skill in the art without creative efforts and combinations of part of embodiments described below shall fall within the protection scope of the present disclosure.

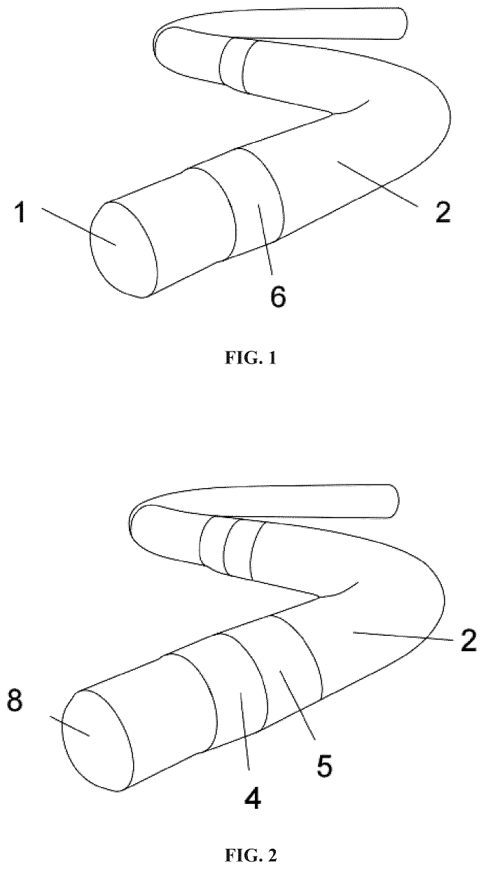

An embodiment of the present disclosure discloses a threadlike sensor. With reference to FIG. 1, a structural schematic diagram of the threadlike sensor in the embodiment of the present disclosure is illustrated. The threadlike sensor includes a thread core 1, an inner insulating layer, an outside electrode layer 6 and an outer insulating layer 2. The inner insulating layer covers the thread core 1 with two ends of the thread core 1 being exposed by the inner insulating layer. The outside electrode layer 6 is disposed outside the inner insulating layer. The outer insulating layer 2 covers the outside electrode layer 6 with two ends of the outside electrode layer 6 being exposed by the outer insulating layer 2. One end of the threadlike sensor is a detection end configured for placement in a human body. The other end of the threadlike sensor is an interface end configured for external connection. The thread core 1 and the outside electrode layer 6 are configured for sensitivity testing.

Specifically, the inner insulating layer and the outer insulating layer 2 are configured for insulation. The inner insulating layer is configured to avoid a contact between the thread core 1 and the outside electrode layer 6 from affecting a test result of the sensitivity testing. The outer insulating layer 2 is configured to avoid other conductive parts from affecting the test result of the sensitivity testing.

In the embodiment of the present disclosure, the thread core 1 and the outside electrode layer 6 are configured for sensitivity testing. Specifically, the thread core 1 and the outside electrode layer 6 form a two-electrode system or a three-electrode system for the sensitivity testing.

One end of the threadlike sensor is a detection end configured for placement in a human body. The other end of the threadlike sensor is an interface end configured for external connection. Therefore, between the two ends of the thread core 1 exposed by the inner insulating layer, one end located at the detection end is configured for placement into the human body, and the other end is configured for external connection. Between the two ends of the outside electrode layer 6 exposed by the outer insulating layer 2, one end located at the detection end is configured for placement into the human body, and the other end is configured for external connection.

The threadlike sensor of the embodiment of the present disclosure includes the thread core 1, the inner insulating layer, the outside electrode layer 6 and the outer insulating layer 2, and has the advantages of simple structure, convenient fabrication and low cost. Moreover, the threadlike sensor is of a flexible needle type structure and may be flexibly inserted into a human body. After being placed into the human body, the threadlike sensor is capable of maintaining a bent state. Due to easy bending, the threadlike sensor may change with the surrounding skin tissue environment when the skin is deformed, and thus may provide more comfort with a small influence on the human body. The thread core 1 and the outside electrode layer 6 form a three-electrode system or a two-electrode system, offering the advantages of mature detection technique and accurate detection.

In some embodiments of the present disclosure, a length of the thread core 1 ranges from 0.5 mm to 15 mm. It will be understood that the length of the thread core 1 is set according to use requirements in practical use. For example, the length of the thread core 1 is 0.5 mm, 0.7 mm, 0.9 mm, 1 mm, 1.2 mm, 1.4 mm or 1.5 mm.

In some embodiments of the present disclosure, an inner insulating wire is wound around the thread core to form the inner insulating layer, and the inner insulating wire is wound by at least one layer. With the above-mentioned structure, when the threadlike sensor is bent, the inner insulating layer may be prevented from being cracked and fractured due to serious bending of the inner insulating layer, and the inner insulating wire can guarantee the insulation effect. Moreover, a force support is formed after the threadlike sensor is bent, allowing the threadlike sensor to be in the bent state. The threadlike sensor does not actively restore to an original state and provides more comfort with a small influence on the human body.

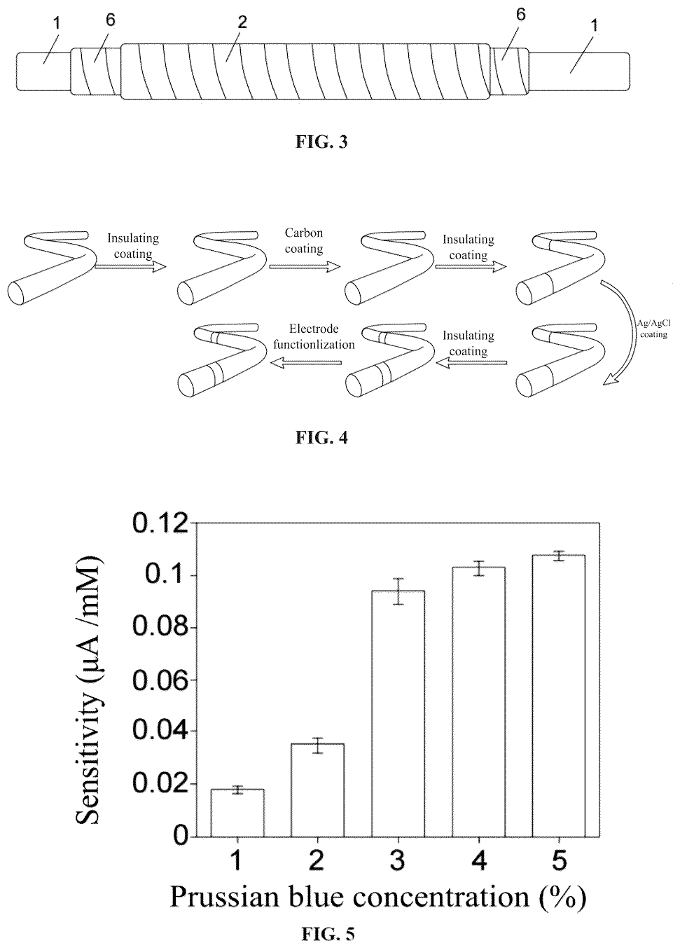

In some embodiments of the present disclosure, with reference to FIG. 3, an outer insulating wire is wound around the outside electrode layer 6 to form the outer insulating layer, and the outer insulating wire is wound by at least one layer. With the above-mentioned structure, when the threadlike sensor is bent, the outer insulating layer 2 may be prevented from being cracked and fractured due to serious bending of the outer insulating layer 2, and the outer insulating wire can guarantee the insulation effect. Moreover, a force support is formed after the threadlike sensor is bent, allowing the threadlike sensor to be in the bent state. The threadlike sensor does not actively restore to an original state and provides more comfort with less impact on the human body.

In some embodiments of the present disclosure, the inner insulating layer is an insulating coating or an insulating plating; and/or the outer insulating layer 2 is an insulating coating or an insulating plating. The above-mentioned structures of the inner insulating layer and the outer insulating layer 2 have the advantage of being simple and easy to fabricate.

In some embodiments of the present disclosure, with reference to FIG. 3, the outside electrode layer 6 is formed by winding the outside electrode wire around the inner insulating layer, and the outside electrode wire is wound by at least one layer. With the above-mentioned structure, a fixed connection of the outside electrode layer 6 and the inner insulating layer can be realized.

In some embodiments of the present disclosure, the outside electrode layer 6 is a thin film electrode. The outside electrode layer 6 is prepared outside the inner insulating layer by physical vapor deposition using a vacuum coating machine.

In some embodiments of the present disclosure, the thread core 1 is a working electrode; a specific enzyme 3 is disposed on an outer wall surface of the working electrode; the inner insulating layer covers the specific enzyme 3; and the specific enzyme 3 located at the detection end is exposed by the inner insulating layer.

In some embodiments of the present disclosure, the specific enzyme 3 includes glucose oxidase for detecting glucose, or lactate oxidase for detecting lactate, or uricase for detecting uric acid, or a mixture of creatinine amidohydrolase, creatine amidinohydrolase and sarcosine oxidase for detecting creatinine, or cholesterol oxidase for detecting cholesterol, or a mixture of lipase, glycerol kinase and glycerol phosphate oxidase for detecting triglyceride.

In some embodiments of the present disclosure, the specific enzyme 3 is mixed with an immobilizing agent and then immobilized onto the working electrode. Or, the specific enzyme 3 is directly immobilized onto the working electrode.

In some embodiments of the present disclosure, the immobilizing agent includes a glutaraldehyde or a chitosan or a perfluorinated sulfonic acid resin. The glutaraldehyde is an organic compound, which is a colorless or yellowish transparent liquid, soluble in water, and freely soluble in organic solvents such as ethanol and diethyl ether. The chitosan is a product obtained by depriving part of acetyl groups from a natural polysaccharide chitin and has a plurality of physiological functions such as biodegradability, biocompatibility, nontoxicity, antibacterial activity, cancer resistance, lipid lowering and immunity enhancing. The perfluorinated sulfonic acid resin is the known strongest solid superacid and has the characteristics of good heat resistance, high chemical stability and mechanical strength, etc. The glutaraldehyde or the chitosan or the perfluorinated sulfonic acid resin is suitable for serving as the immobilizing agent for a biosensor.

In some embodiments of the present disclosure, the thread core 1 is a soft threadlike titanium strip or a soft threadlike gold strip. The thread core 1 is of a flexible short needle type structure and is bendable and suitable for insertion into the skin's surface.

In some embodiments of the present disclosure, a diameter of the thread core 1 ranges from 0.05 mm to 0.5 mm. When the diameter of the thread core 1 is within the above-mentioned range, the thread core 1 may be of a soft threadlike structure. After being placed into the human body, the thread core 1 is capable of maintaining the bent state, and the threadlike sensor may change with the surrounding skin tissue environment when the skin is deformed, and thus may provide more comfort with a small influence on the human body.

The diameter of the thread core 1 is specifically chosen according to use requirements in practical use. For example, the diameter of the thread core 1 is 0.05 mm, 0.1 mm, 0.15 mm, 0.25 mm, 0.35 mm, 0.4 mm, 0.45 mm or 0.5 mm.

In some embodiments of the present disclosure, the thread core includes an insulating inner core and a Prussian blue-graphite paste layer covering the insulating inner core; and the thread core is a working electrode.

In some embodiments of the present disclosure, the outside electrode layer 6 is a counter electrode 4. In this case, the thread core 1 and the outside electrode layer 6 form a two-electrode system.

In some embodiments of the present disclosure, as shown in FIG. 2, the outside electrode layer 6 includes a counter electrode 4 and a reference electrode 5. A middle insulating layer is disposed between the counter electrode 4 and the reference electrode 5. One end of the counter electrode 4 and one end of the reference electrode 5 are arranged stepwise, and the other end of the counter electrode 4 and the other end of the reference electrode 5 are arranged stepwise. Two ends of the counter electrode 4 and two ends of the reference electrode 5 are exposed by the outer insulating layer 2. In this case, the thread core 1 is a working electrode 8 and forms a three-electrode system together with the counter electrode 4 and the reference electrode 5.

Further, a material of the working electrode may be chosen according to use requirements. For example, the material of the working electrode may be at least one of titanium, gold, platinum, and composite materials based on titanium, gold and platinum.

Further, the working electrode may also be made by an insulating inner core and a Prussian blue-graphite paste layer covering the insulating inner core.

Further, materials of the counter electrode 4 and the reference electrode 5 may be chosen according to use requirements. For example, the materials of the counter electrode 4 and the reference electrode 5 are silver, silver chloride or the like.

In some embodiments of the present disclosure, the thread core is a counter electrode, and the outside electrode layer is a working electrode. Or, the thread core is a working electrode, and the outside electrode layer is a counter electrode. Or, the thread core is a working electrode, and the outside electrode layer includes a counter electrode and a reference electrode; a middle insulating layer is disposed between the counter electrode and the reference electrode; one end of the counter electrode and one end of the reference electrode are arranged stepwise, and the other end of the counter electrode and the other end of the reference electrode are arranged stepwise; and two ends of the counter electrode and two ends of the reference electrode are exposed by the outer insulating layer. Or, the thread core is a counter electrode, and the outside electrode layer includes a working electrode and a reference electrode; a middle insulating layer is disposed between the working electrode and the reference electrode; one end of the working electrode and one end of the reference electrode are arranged stepwise, and the other end of the working electrode and the other end of the reference electrode are arranged stepwise; and two ends of the working electrode and two ends of the reference electrode are exposed by the outer insulating layer. That is, when the thread core and the outside electrode layer form a two-electrode system, positions of the counter electrode and the working electrode may be interchanged, and the specific enzyme 3 is immobilized onto the working electrode. When the thread core and the outside electrode layer form a three-electrode system, positions of the counter electrode, the working electrode and the reference electrode may be interchanged, and the specific enzyme 3 is immobilized onto the working electrode. The two-electrode system or the three-electrode system is configured for sensitivity testing.

In some embodiments of the present disclosure, the interface end of the threadlike sensor is connected to a circuit module or a chip through a conducting plate. The circuit module or the chip converts a current generated by the threadlike sensor into a voltage signal, amplifies and filters the voltage signal, and then stores and transmits the voltage signal.

A specific embodiment of the threadlike sensor of the present disclosure is described below.

The threadlike sensor uses titanium/gold or titanium/platinum (the titanium acts as a base adhesion layer, and gold or platinum acts as a sensing electrode) as the working electrode, silver/silver chloride as the reference electrode 5/counter electrode 4, and a 50 mM buffer solution at a pH of 7.5 as an electrolyte. A detection voltage is set to −0.1 V (a reference voltage for Ag/AgCl), and an Electrochemical Impedance Spectroscopy (EIS) testing range is 1×10⁻² to 1×10⁴.

Detection of non-targeted metabolites: 5 μL of 2 mM lactic acid, 5 mM uric acid, 5 mM dopamine, 5 mM ascorbic acid and 10 mM glucose is added to 200 μL of buffer solution, and an I-T curve is recorded. Temperature testing: the threadlike sensor is put on a hot plate, and a glucose current feedback within a temperature range of 20° C. to 40° C. is recorded. pH detection: a phosphate solution at a pH of 6 to 8 is used as a buffer solution for detecting glucose. Flexibility testing: a threadlike sensor is bent at different angles to detect glucose. Repetitive experiment: a single threadlike sensor is subjected to constant voltage current detection with 20 mM glucose continuously for 60 times. After each detection, the solution is taken out and washed twice with the buffer solution, and the fresh solution is added for next measurement.

When the threadlike sensor is inserted into the skin, the detection end is in contact with interstitial fluid. The glucose oxidase immobilized on the surface of the working electrode catalyzes glucose molecules in the vicinity of the working electrode such that the glucose molecules are transformed into the gluconic acid and H₂O₂ is generated. The H₂O₂ is oxidized with a voltage of −0.1 V under the catalysis of Prussian blue to generate reaction electrons and cause a current change. Generally, a magnitude of the current is in a linear relationship with a glucose concentration. A current value is detected to obtain a corresponding glucose concentration.

After being inserted into the skin, the threadlike sensor can be bent freely at any angle and can actively maintain the bent state without generating turning stress. With such a property, the threadlike sensor can be easily bent at any angle into a desired shape to be implanted into the naturally bent skin of the human body and may not generate the turning stress when implanted into the skin. When the skin is deformed, the threadlike sensor may change with the surrounding skin tissue environment, and the foreign body sensation during wearing is reduced.

Another specific embodiment of the threadlike sensor of the present disclosure is described below.

With reference to FIG. 4, a titanium wire is evenly coated with an insulating ink to form an internal insulating layer. A prepared Prussian blue-graphite paste is applied to cover the titanium wire coated with the insulating ink, and then heated and dried to form a working layer of the sensor. Next, a layer of insulating ink is coated as an inner insulating layer. Next, Ag/AgCl is continuously coated as a reference electrode of the system. Thus, a sensor system of an annular layered model is prepared. Such a system has the characteristics of a compact structure, a small area and a large space utilization ratio.

FIG. 5 shows sensitivities of the material when different concentrations of Prussian blue are used as the working electrodes. Results show that the sensitivity increases with increasing concentration of the Prussian blue and when the concentration reaches 4%, the sensitivity does not change much. This is because the working electrode has a limited surface area and is covered with sufficient Prussian blue molecules, and a surface accommodating limit is achieved. Thus, if the concentration of the Prussian blue is continuously increased, only a thickness thereof will be increased and the sensitivity will not be effectively improved. Moreover, in consideration of the economic benefit, 4% Prussian blue is selected as the concentration of the Prussian blue for our working electrode.

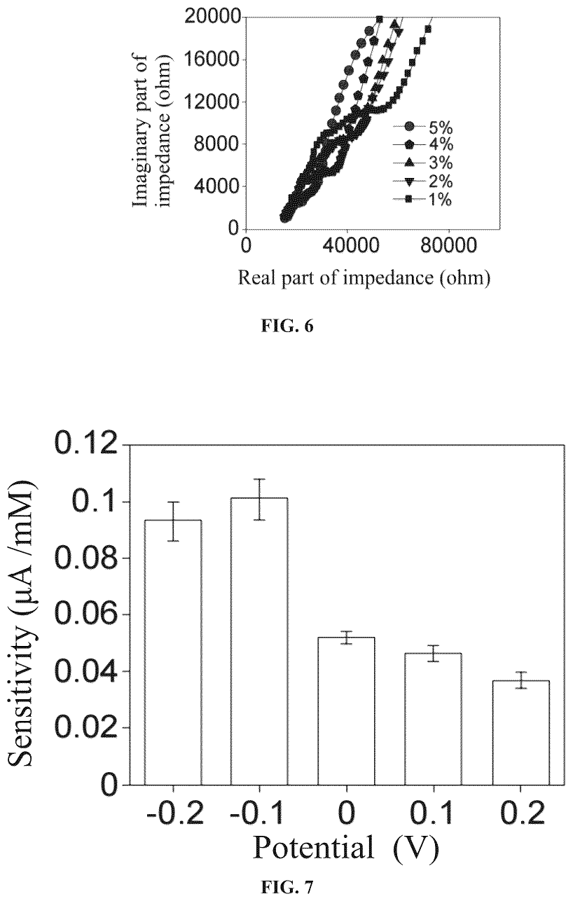

Likewise, FIG. 6 shows EIS patterns of threadlike sensors prepared with different concentrations of Prussian blue. As can be seen from FIG. 6, at a high-frequency phase, the concentration of 4% corresponds to a smallest impedance radius, which is affected by an electrochemical reaction rate of the electrode in this phase. Therefore, the 4% Prussian blue electrode has the highest reaction activity. FIG. 7 shows sensitivity changes of the threadlike sensor under different working voltages. A Prussian blue electrode is an electrochemical sensor and follows the following principle: glucose oxidase catalyzes the oxidation of glucose in the presence of glucose; the Prussian blue is a reducible ferrous complex, and when the Prussian blue is reduced into monovalent iron, a decrease in the electrode potential may be caused; and therefore, the Prussian blue can be used as a mediator for sensing glucose. The surface of the working electrode is modified with the Prussian blue such that the sensitivity and stability of the electrode are enhanced. Moreover, the oxidation potential of glucose can be reduced by Prussian blue to −0.1 V vs Ag/AgCl, and under such a potential, the influence of other interfering substances on detection can be prevented. It can be seen that when the working voltage is −0.1 V, the sensitivity is the highest, which is −0.1 μA/mM.

An increase in potential difference between the electrode and the electrolyte may result in that Fe (III) ions in Prussian blue are reduced into Fe (II) ions, whereby the property of the electrode reaction is changed. In this case, the electrode reaction changes from a two-electron transfer process to a single-electron transfer process. As a result, the reduction efficiency is reduced, leading to an inaccurate detection result. Moreover, if the voltage is too high, an oxidation reaction may be induced. Consequently, the Prussian blue layer on the surface of the electrode is destroyed, resulting in electrode performance degradation. Because the Fe (III) ions have a high electron cloud density in Prussian blue molecules and are prone to reduction, the selection of a higher voltage may lead to the occurrence of the single-electron transfer process. When the potential is higher, it is farther away from the working point of the Prussian blue, preventing glucose from being oxidized effectively. Under the potential of −0.1 V, hydrogen peroxide is capable of functioning effectively in catalytic oxidation of Prussian blue, thus generating a strong current response. Moreover, the potential does not cause an electrochemical reduction of Prussian blue, thus guaranteeing the stability and reliability of a detection signal. Therefore, −0.1 V is selected as the working voltage of the system.

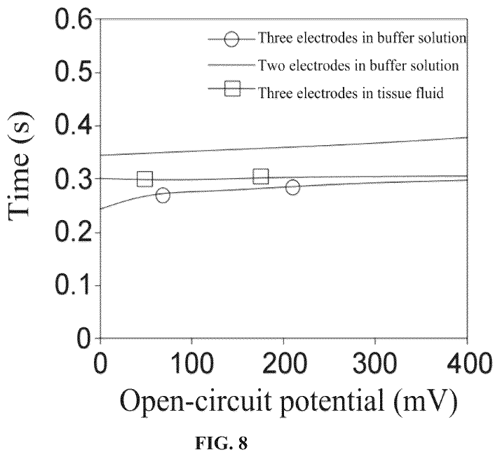

FIG. 8 shows open-circuit potentials in a working state in different environments with an Ag/AgCl electrode as the reference electrode 5. The potential of the reference electrode 5 is affected not only by its internal system (e.g., the Ag/AgCl electrode) but also by an external environment (e.g., the electrolyte or the temperature). By testing an open-circuit voltage of the reference electrode 5, whether the reference electrode 5 reaches a stable potential may be confirmed. If the potential of the reference electrode 5 changes, the measured potential of the working electrode may change accordingly, thus affecting the accuracy and the repeatability of the electrochemical reaction. Therefore, by testing the open-circuit voltage of the reference electrode 5, it can be guaranteed that the reference electrode 5 has sufficient potential stability, thus improving the accuracy and the reliability of electrochemical measurement. As can be seen from FIG. 8, the potential change of the electrode within 10 minutes is within 10%, indicating the potential stability of Ag/AgCl as the reference electrode 5.

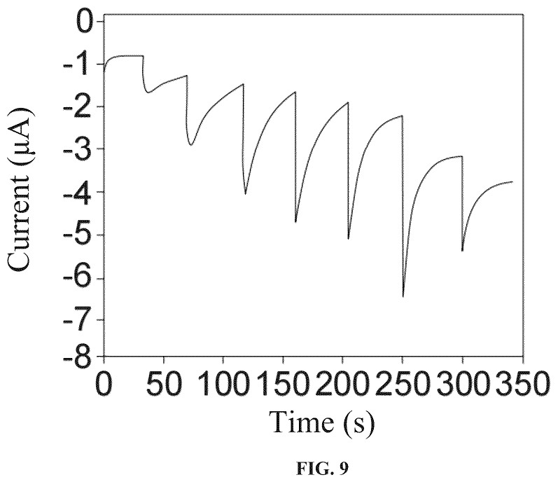

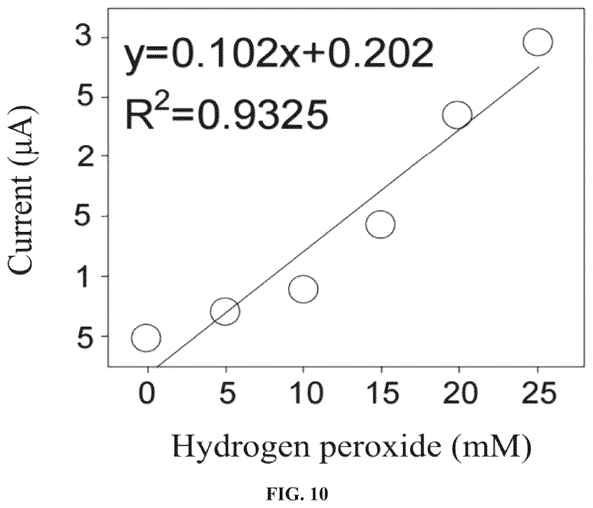

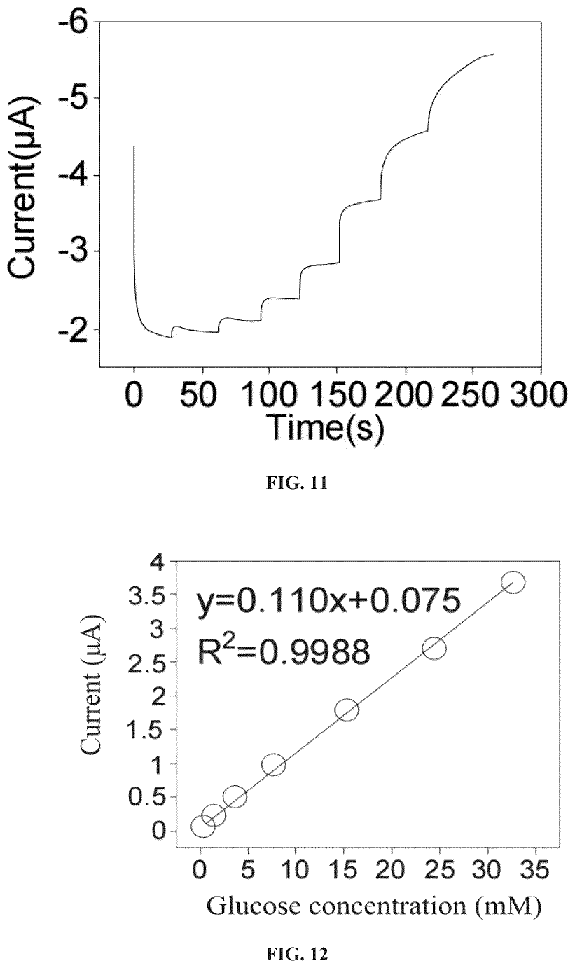

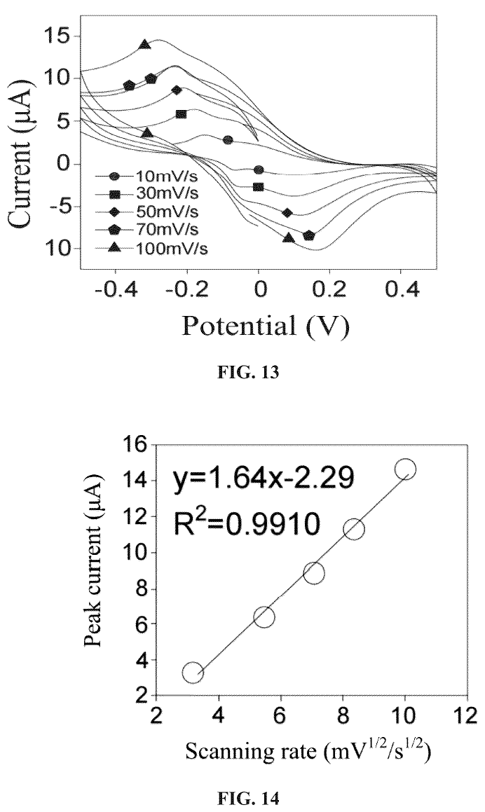

FIG. 9 shows a current-time curve of detecting the H₂O₂ in a buffer solution, and the threadlike sensor has the sensitivity of 0.102 μA/mM (FIG. 10). FIG. 11 shows a current-time curve of detecting glucose, with the sensitivity of 0.110 μA/mM (FIG. 12), a detection range of 0 to 30 mM and a detection limit of 27 μM. A glucose concentration in interstitial fluid is usually within a range of 0.7 mM to 8.3 mM (12.6 mg/dL to 149.4 mg/dL), which can meet the accuracy range of detection. FIG. 13 shows a CV curve of the threadlike sensor in a glucose solution. It can be seen that an oxidation peak of CV is in the vicinity of −0.1 V, indicating that glucose can be detected under such a voltage. Furthermore, since a peak current is directly proportional to the square root of a scanning rate, it may indicate that a reaction rate is affected by diffusion control from the Levich equation (FIG. 14).

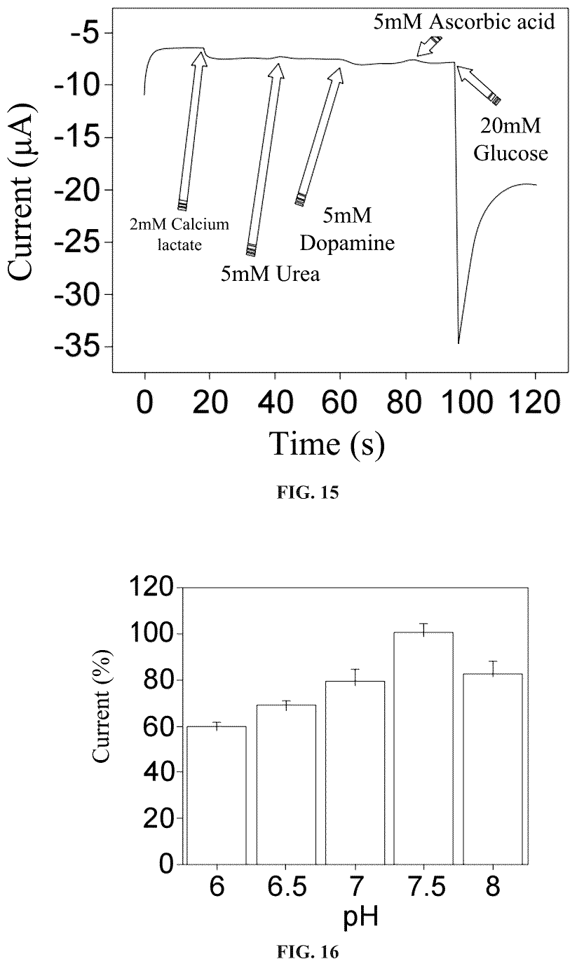

FIG. 15 shows the current responses of the threadlike sensor to different interfering substances. Since substances, such as ascorbic acid, react similarly to glucose at the oxidation potential, the oxidation current of ascorbic acid may be incorrectly measured as the oxidation current of glucose, thus causing an error. In addition, metabolites such as pyruvic acid and lactic acid will affect the diffusion and transport of glucose and may compete with glucose for reaction. These interfering substances may cause a drift and instability of a glucose signal. Therefore, we chose the Prussian blue as an electronic mediator to reduce the working potential to ensure that the oxidation potentials of glucose and the interfering substances do not overlap. The metabolites such as the pyruvic acid and the lactic acid will affect the diffusion and transport of glucose, may affect the pH of the extracellular fluid to change a relative concentration of glucose and ions in the liquid, and may compete with glucose for reaction. These interfering substances may cause a drift and instability of a glucose signal. Here, we chose nafion to restrict these substances from entering the reaction layer of the electrode, eliminating their interference. As can be seen from the figure, the dropwise adding of various interfering substances does not cause a significant current change of the threadlike sensor, and a large current response is exhibited for glucose, indicating that the threadlike sensor has good anti-interference capability. FIG. 16 shows sensitivity changes of the threadlike sensor at different pH values. The pH of the human interstitial fluid (ISF) is usually between 7.35 and 7.45. Within this range, the sensitivity change of the threadlike sensor is about 10%, indicating that the threadlike sensor can meet the pH requirement.

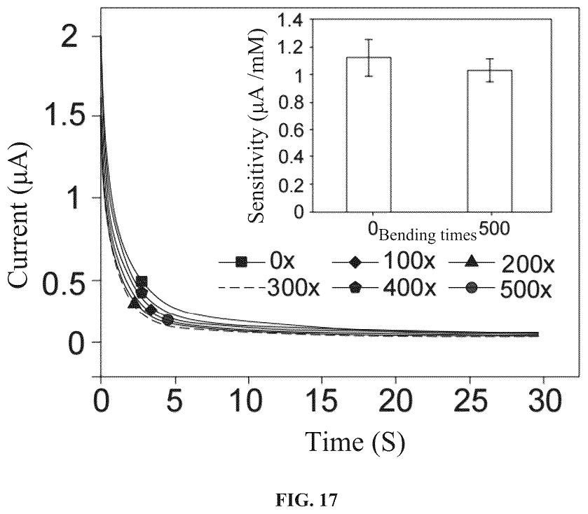

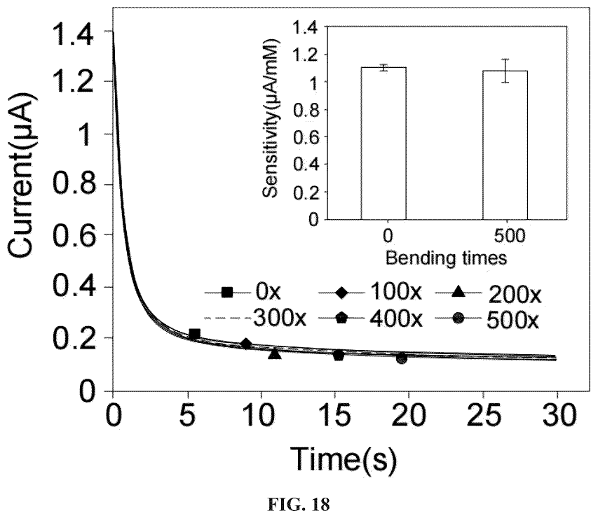

The flexibility of the threadlike sensor directly affects the fit and the stability of the threadlike sensor with the skin, thus affecting the accuracy of measurement. If the threadlike sensor cannot adapt to the shape and the motion of the skin or is prone to loosing or moving, a measurement error will be generated. Moreover, the flexibility of the threadlike sensor may further affect the comfort of wearing and the duration of use, and therefore, better flexibility may improve the comfort and satisfaction of a user. FIG. 17 and FIG. 18 show diagrams of current responses after bending and folding in a vertical direction and vertically, respectively, showing that the sensitivity of the threadlike sensor still remains stable even after being folded for a plurality of times.

An embodiment of the present disclosure further discloses a wearable device including a wearing unit provided with the threadlike sensor described above. The embodiment of the present disclosure has no particular limitation on the wearing unit. The wearing unit is, for example, a wristlet or a clothing.

When the thread core 1 and the outside electrode layer are used for sensitivity testing for glucose, the flexible short needle type wearable device is capable of realizing long-term glucose monitoring to prevent the occurrence of diabetes. More frequent and more accurate blood glucose data can be obtained, helping a patient to better monitor the blood glucose level. Moreover, the threadlike sensor is simple in design, easy to use, and will not affect the normal life of the patient. The flexible short needle type wearable device is capable of continuously monitoring the blood glucose level of a patient with diabetes and providing real-time blood glucose data, allowing the patient to better control their blood glucose levels and prevent them from getting too high or too low. Moreover, such a threadlike sensor may also help a doctor to better evaluate the disease status of a patient and to give more targeted treatment suggestions. Furthermore, the flexible short needle type wearable device is made of a flexible material and designed into a needle shape and can be worn easily by a patient with minimal impact on the skin. Therefore, the patient can wear it for a long time without feeling uncomfortable.

In some embodiments of the present disclosure, the wearable device further includes a recorder. The interface end of the threadlike sensor is connected to the recorder. When the wearable device is used, the threadlike sensor is inserted into the skin to measure the blood glucose level. The recorder is capable of displaying the blood glucose level data in real time and storing the data in a memory for later analysis and evaluation.

The wearable device of the embodiment of the present disclosure is very simple to use. After the patient wears the wearable device, the threadlike sensor is inserted into the skin's surface. The patient can monitor the blood glucose level at any time and adjust the diet and the exercise plan according to the blood glucose level.

In some embodiments of the present disclosure, the wearable device can also be used in combination with other medical devices or software, which will not be limited in the embodiments of the present disclosure. For example, the wearable device is used in combination with an insulin pump and installed with diabetes management software. When the wearable device is installed with diabetes management software, data can be transmitted to the diabetes management software in real time, facilitating analysis and evaluation by a doctor. The blood glucose level may be tested at intervals of a set time, e.g., 5 minutes. The wearable device is capable of helping the patient to better manage the diabetes.

To sum up, the patient can use the wearable device anytime anywhere without complex operation and device replacement. Moreover, the wearable device has excellent characteristics of high accuracy, high reliability, high comfort, etc., and is capable of helping the patient with the diabetes to better manage the disease and improve the living quality. The living quality of the patient can be improved.

The thread core 1 and the outside electrode layer may also be used for sensitivity testing in other aspects, which will not be limited in the embodiments of the present disclosure. For example, the wearable device is used for diabetes monitoring, exercise monitoring, health management and clinical application. For the diabetes monitoring, the threadlike sensor is useful for monitoring the blood glucose level in real time and provides an immediate feedback to the patient to adjust the diet, exercise and medication use of the patient. For the exercise monitoring, the threadlike sensor is useful for monitoring the physiological change in the body in real time during exercise. For the health management, the threadlike sensor is useful for monitoring the health condition of a person and providing early warning information for a potential health problem. For the clinical application, the threadlike sensor is useful for monitoring the blood glucose level in the body in real time and provides an immediate feedback for a clinical decision.

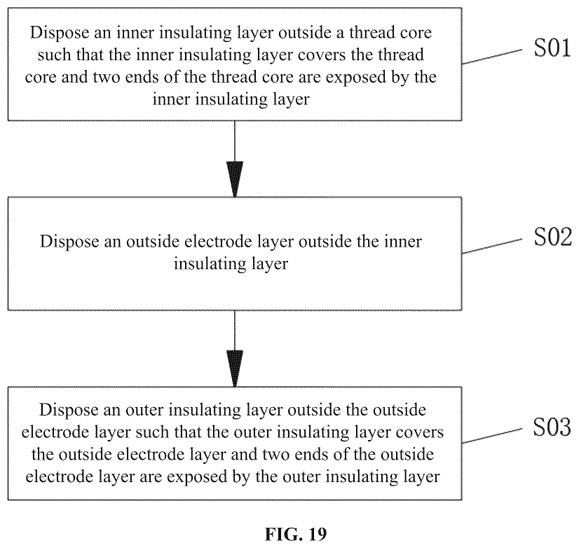

An embodiment of the present disclosure provides a method for fabricating a threadlike sensor, as shown in FIG. 19, including the following steps.

S01, an inner insulating layer is disposed outside a thread core such that the inner insulating layer covers the thread core and two ends of the thread core are exposed by the inner insulating layer.

In this step, when the thread core is a working electrode, a specific enzyme further needs to be disposed on the outer wall surface of the working electrode.

In this case, the step further includes:
place the thread core in a specific enzyme solution, take out and dry the thread core, and then dispose the inner insulating layer outside the thread core.

It will be understood that the specific enzyme solution is provided according to use requirements. The specific enzyme solution is a mixture of Prussian blue and graphite paste, and the concentration of the Prussian blue may be 0.5% to 6%. For another example, the specific enzyme solution includes 20 U/μl glucose oxidase and 2% glutaraldehyde in a ratio of 1:1.

A material of the inner insulating layer may be an insulating ink.

S02, an outside electrode layer is disposed outside the inner insulating layer.

S03, an outer insulating layer is disposed outside the outside electrode layer such that the outer insulating layer covers the outside electrode layer and two ends of the outside electrode layer are exposed by the outer insulating layer.

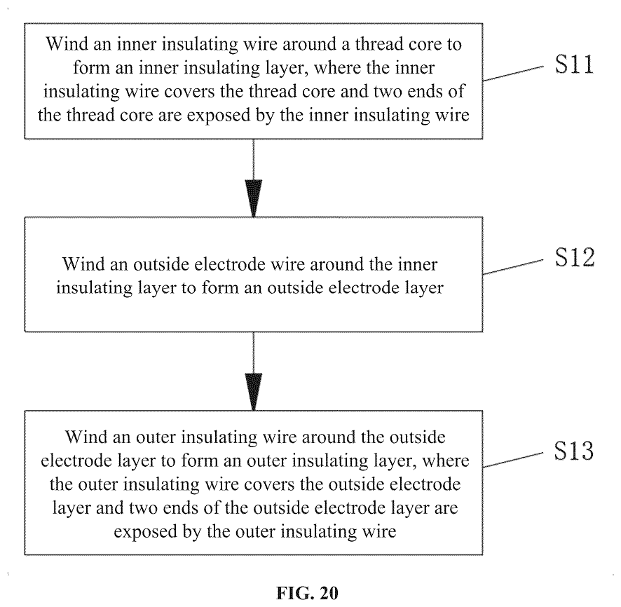

An embodiment of the present disclosure discloses a method for fabricating another threadlike sensor. As shown in FIG. 20, the method includes the following steps when an inner insulating layer includes an inner insulating wire, an outside electrode layer includes an outside electrode wire and an outer insulating layer includes an outer insulating wire.

S11, the inner insulating wire is wound around a thread core to form the inner insulating layer, where the inner insulating wire covers the thread core and two ends of the thread core are exposed by the inner insulating wire.

S12, the outside electrode wire is wound around the inner insulating layer to form the outside electrode layer.

S13, the outer insulating wire is wound around the outside electrode layer to form the outer insulating layer, where the outer insulating wire covers the outside electrode layer and two ends of the outside electrode layer are exposed by the outer insulating wire.

The winding of the inner insulating wire, the winding of the outside electrode wire and the winding of the outer insulating wire may be carried out by using the prior art as long as the insulation requirement and the requirement of being firm without falling can be meet.

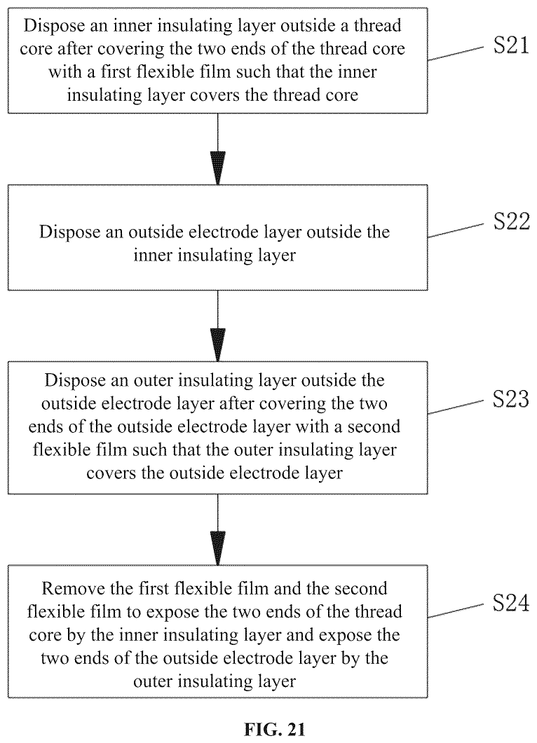

An embodiment of the present disclosure discloses a method for fabricating a third threadlike sensor. As shown in FIG. 21, the method includes the following steps when each of an inner insulating layer, an outside electrode layer and an outer insulating layer is one of a coating and a plating.

S21, the inner insulating layer is disposed outside a thread core after the two ends of the thread core are covered with a first flexible film such that the inner insulating layer covers the thread core.

In this step, a material of the inner insulating layer is an insulating ink. In this case, the thread core with the two ends covered with the first flexible film is placed into the insulating ink and then heated and dried to obtain the inner insulating layer.

S22, the outside electrode layer is disposed outside the inner insulating layer.

In an example, when the outside electrode layer in this step is a counter electrode, a method of disposing the outside electrode layer outside the inner insulating layer includes preparing the counter electrode outside the inner insulating layer by physical vapor deposition using a vacuum coating machine.

In another example, when the outside electrode layer in this step includes a counter electrode and a reference electrode, the step of disposing the outside electrode layer outside the inner insulating layer further includes the following sub-steps.

S221, the counter electrode is prepared outside the inner insulating layer by physical vapor deposition using the vacuum coating machine.

S222, two ends of the counter electrode are covered with a third flexible film. The regions covered with the third flexible film are configured for placement into a human body and for external connection, respectively.

S223, a middle insulating layer is disposed outside the counter electrode such that the middle insulating layer covers the counter electrode.

In some embodiments, a material of the middle insulating layer is an insulating ink. In this case, the thread core with the two ends covered with the third flexible film is placed into the insulating ink and then heated and dried to obtain the middle insulating layer.

S224, the reference electrode is deposited outside the middle insulating layer by physical vapor deposition using the vacuum coating machine.

The third flexible film may be removed after step S224 or in step S24.

It will be understood that the counter electrode and the reference electrode may be interchanged. In this case, the reference electrode is prepared in step S021, while the counter electrode is prepared in step S024.

S23, the outer insulating layer is disposed outside the outside electrode layer after the two ends of the outside electrode layer are covered with a second flexible film such that the outer insulating layer covers the outside electrode layer.

In some embodiments, a material of the outer insulating layer is an insulating ink, and the outside electrode layer with the two ends covered with the second flexible film is placed into the insulating ink and then heated and dried to obtain the outer insulating layer.

S24, the first flexible film and the second flexible film are removed to expose the two ends of the thread core by the inner insulating layer and expose the two ends of the outside electrode layer by the outer insulating layer.

The threadlike sensor fabricated by the above steps is a sensor of an annular layered model, which has the advantages of a compact structure, a small area and a large space utilization ratio.

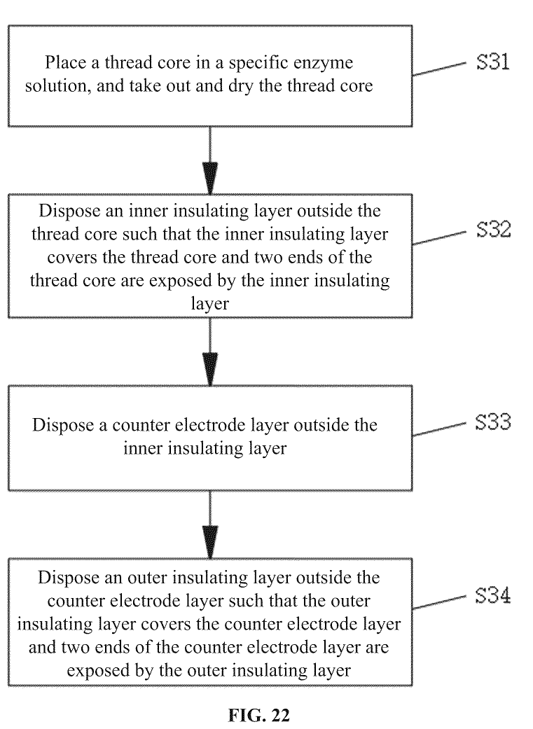

Alternatively, a specific example of the method for fabricating a threadlike sensor is as follows, where a thread core is a working electrode and an outside electrode layer is a counter electrode. As shown in FIG. 22, the method includes the following steps:

S31, place the thread core in a specific enzyme solution, and take out and dry the thread core;

S32, dispose an inner insulating layer outside the thread core such that the inner insulating layer covers the thread core and two ends of the thread core are exposed by the inner insulating layer;

S33, dispose a counter electrode layer outside the inner insulating layer; and

S34, dispose an outer insulating layer outside the counter electrode layer such that the outer insulating layer covers the counter electrode layer and two ends of the counter electrode layer are exposed by the outer insulating layer.

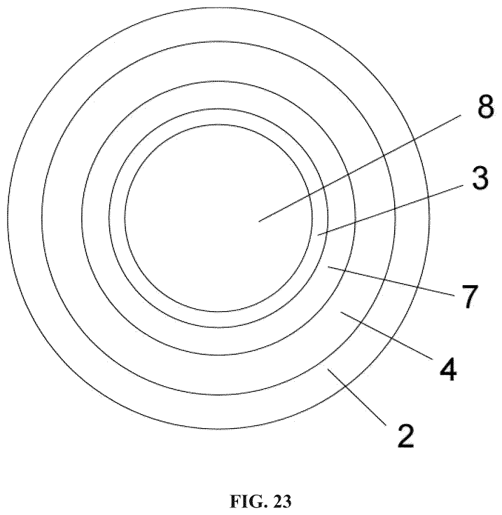

Alternatively, a specific example of the threadlike sensor, as shown in FIG. 23, includes a working electrode 8, a specific enzyme 3, an inner insulating layer 7, a counter electrode 4 and an outer insulating layer in sequence from inside to outside.

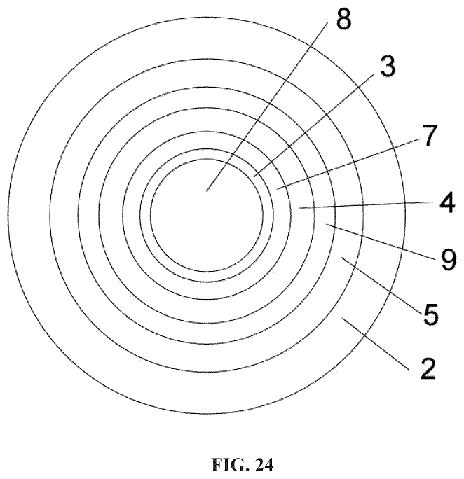

Alternatively, another specific example of the threadlike sensor, as shown in FIG. 24, includes a working electrode 8, a specific enzyme 3, an inner insulating layer 7, a counter electrode 4, a middle insulating layer 9, a reference electrode 5 and an outer insulating layer in sequence from inside to outside.

It will be understood that the positions of the working electrode 8, the counter electrode 4 and the reference electrode 5 in the above-mentioned structure may be interchanged, where the working electrode 8 needs to be immobilized onto the specific enzyme 3.

It should be noted that relational terms herein such as first and second are merely used to distinguish one entity or operation from another entity or operation without necessarily requiring or implying any actual such relationship or order between such entities or operations. In addition, terms “include”, “comprise”, or any other variations thereof are intended to cover a non-exclusive inclusion, so that a process, a method, an article, or a device including a series of elements not only includes those elements, but also includes other elements that are not explicitly listed, or also includes inherent elements of the process, the method, the article, or the device. Without more restrictions, the elements defined by the sentence “including a . . . ” do not exclude the existence of other identical elements in a process, method, article, or device including the elements.

Each embodiment in this description is described in a related manner. Each embodiment focuses on the difference from other embodiments, and the same and similar parts between the embodiments may refer to each other. Since the embodiments of an apparatus, an electronic device, a computer readable storage medium and a computer program product thereof containing instructions are basically similar to the method embodiments, the descriptions thereof are relatively simple. For the related parts, a reference can be made to the descriptions of the method embodiments.

The foregoing are merely descriptions of the preferred embodiments of the present disclosure and not intended to limit the protection scope of the present disclosure. Any modifications, equivalent replacements, improvements and the like made within the spirit and principle of the present disclosure should be included within the protection scope of the present disclosure.

What is claims is:

1. A threadlike sensor, comprising a thread core, an inner insulating layer, an outside electrode layer and an outer insulating layer, wherein the inner insulating layer covers the thread core with two ends of the thread core being exposed by the inner insulating layer; the outside electrode layer is disposed outside the inner insulating layer; the outer insulating layer covers the outside electrode layer with two ends of the outside electrode layer being exposed by the outer insulating layer;
one end of the threadlike sensor is a detection end configured for placement in a human body; the other end of the threadlike sensor is an interface end configured for external connection; and the thread core and the outside electrode layer are configured for sensitivity testing.

2. The threadlike sensor according to claim 1, wherein an inner insulating wire is wound around the thread core to form the inner insulating layer, and the inner insulating wire is wound by at least one layer; and/or an outer insulating wire is wound around the outside electrode layer to form the outer insulating layer, and the outer insulating wire is wound by at least one layer.

3. The threadlike sensor according to claim 1, wherein the outside electrode layer is formed by winding an outside electrode wire around the inner insulating layer, and the outside electrode wire is wound by at least one layer.

4. The threadlike sensor according to claim 1, wherein the inner insulating layer is an insulating coating or an insulating plating; and/or the outer insulating layer is an insulating coating or an insulating plating.

5. The threadlike sensor according to claim 1, wherein the thread core is a working electrode; a specific enzyme is disposed on an outer wall surface of the working electrode; the inner insulating layer covers the specific enzyme; and the specific enzyme located at the detection end is exposed by the inner insulating layer.

6. The threadlike sensor according to claim 1, wherein the thread core is a soft threadlike titanium strip or a soft threadlike gold strip.

7. The threadlike sensor according to claim 1, wherein the thread core comprises an insulating inner core and a Prussian blue-graphite paste layer covering the insulating inner core; and the thread core is a working electrode.

8. The threadlike sensor according to claim 1, wherein
the thread core is a counter electrode, and the outside electrode layer is a working electrode; or,
the thread core is a working electrode, and the outside electrode layer is a counter electrode; or,
the thread core is a working electrode, and the outside electrode layer comprises a counter electrode and a reference electrode; a middle insulating layer is disposed between the counter electrode and the reference electrode; one end of the counter electrode and one end of the reference electrode are arranged stepwise, and the other end of the counter electrode and the other end of the reference electrode are arranged stepwise; and the two ends of the counter electrode and the two ends of the reference electrode are exposed by the outer insulating layer; or,
the thread core is a counter electrode, and the outside electrode layer comprises a working electrode and a reference electrode; a middle insulating layer is disposed between the working electrode and the reference electrode; one end of the working electrode and one end of the reference electrode are arranged stepwise, and the other end of the working electrode and the other end of the reference electrode are arranged stepwise; and the two ends of the working electrode and the two ends of the reference electrode are exposed by the outer insulating layer.

9. A wearable device, comprising a wearing unit provided with the threadlike sensor according to claim 1.

10. The wearable device according to claim 9, wherein an inner insulating wire is wound around the thread core to form the inner insulating layer, and the inner insulating wire is wound by at least one layer; and/or an outer insulating wire is wound around the outside electrode layer to form the outer insulating layer, and the outer insulating wire is wound by at least one layer.

11. The wearable device according to claim 9, wherein the outside electrode layer is formed by winding an outside electrode wire around the inner insulating layer, and the outside electrode wire is wound by at least one layer.

12. The wearable device according to claim 9, wherein the inner insulating layer is an insulating coating or an insulating plating; and/or the outer insulating layer is an insulating coating or an insulating plating.

13. The wearable device according to claim 9, wherein the thread core is a working electrode; a specific enzyme is disposed on an outer wall surface of the working electrode; the inner insulating layer covers the specific enzyme; and the specific enzyme located at the detection end is exposed by the inner insulating layer.

14. The wearable device according to claim 9, wherein the thread core is a soft threadlike titanium strip or a soft threadlike gold strip.

15. The wearable device according to claim 9, wherein the thread core comprises an insulating inner core and a Prussian blue-graphite paste layer covering the insulating inner core; and the thread core is a working electrode.

16. The wearable device according to claim 9, wherein
the thread core is a counter electrode, and the outside electrode layer is a working electrode; or,
the thread core is a working electrode, and the outside electrode layer is a counter electrode; or,
the thread core is a working electrode, and the outside electrode layer comprises a counter electrode and a reference electrode; a middle insulating layer is disposed between the counter electrode and the reference electrode; one end of the counter electrode and one end of the reference electrode are arranged stepwise, and the other end of the counter electrode and the other end of the reference electrode are arranged stepwise; and the two ends of the counter electrode and the two ends of the reference electrode are exposed by the outer insulating layer; or,
the thread core is a counter electrode, and the outside electrode layer comprises a working electrode and a reference electrode; a middle insulating layer is disposed between the working electrode and the reference electrode; one end of the working electrode and one end of the reference electrode are arranged stepwise, and the other end of the working electrode and the other end of the reference electrode are arranged stepwise; and the two ends of the working electrode and the two ends of the reference electrode are exposed by the outer insulating layer.

17. A method for fabricating a threadlike sensor, comprising the following steps:
disposing an inner insulating layer outside a thread core such that the inner insulating layer covers the thread core and two ends of the thread core are exposed by the inner insulating layer;
disposing an outside electrode layer outside the inner insulating layer; and
disposing an outer insulating layer outside the outside electrode layer such that the outer insulating layer covers the outside electrode layer and two ends of the outside electrode layer are exposed by the outer insulating layer.

18. The method for fabricating a threadlike sensor according to claim 17, comprising the following steps when the inner insulating layer comprises an inner insulating wire, the outside electrode layer comprises an outside electrode wire and the outer insulating layer comprises an outer insulating wire:
winding the inner insulating wire around the thread core to form the inner insulating layer, wherein the inner insulating wire covers the thread core and two ends of the thread core are exposed by the inner insulating wire;
winding the outside electrode wire around the inner insulating layer to form the outside electrode layer; and
winding the outer insulating wire around the outside electrode layer to form the outer insulating layer, wherein the outer insulating wire covers the outside electrode layer and two ends of the outside electrode layer are exposed by the outer insulating wire.

19. The method for fabricating a threadlike sensor according to claim 17, comprising the following steps when each of the inner insulating layer, the outside electrode layer and the outer insulating layer is one of a coating and a plating:
disposing the inner insulating layer outside the thread core after covering the two ends of the thread core with a first flexible film such that the inner insulating layer covers the thread core;
disposing the outside electrode layer outside the inner insulating layer;
disposing the outer insulating layer outside the outside electrode layer after covering the two ends of the outside electrode layer with a second flexible film such that the outer insulating layer covers the outside electrode layer;
removing the first flexible film and the second flexible film to expose the two ends of the thread core by the inner insulating layer and expose the two ends of the outside electrode layer by the outer insulating layer.
